(19) United States
(12) Patent Application Publication
(10) Pub. No.: US 2019/0203039 A1
(43) Pub. Date: Jul. 4, 2019

(54) COMPOSITION OF COMPLEX MATERIAL

(71) Applicants: Hyundai Motor Company, Seoul (KR); Kia Motors Corporation, Seoul (KR)

(72) Inventors: Jae Sik Seo, Hwaseong (KR); Sung Ho Yoon, Suwon (KR); Woo Chul Jung, Bucheon (KR)

(21) Appl. No.: 16/175,326

(22) Filed: Oct. 30, 2018

(30) Foreign Application Priority Data
Dec. 29, 2017 (KR) 10-2017-0184581

(51) Int. Cl. C08L 69/00

(52) U.S. Cl. CPC C08L 69/00; C25D 5/54

(57) ABSTRACT

Disclosed is a composition including: an amount of about 60 to 90 wt % of a polymer matrix based on the total weight of the complex material composition and an amount of about 10 to 40 wt % of an inorganic filler based on the total weight of the composition.

### CROSS-REFERENCE TO RELATED APPLICATION

This application claims priority to and the benefit of Korean Patent Application No. 10-2017-0184581 filed in the Korean Intellectual Property Office on Dec. 29, 2017, the entire contents of which are incorporated herein by reference.

### TECHNICAL BACKGROUND

The present invention relates to a complex material composition, or a composition that may be used for interior and exterior parts of a vehicle.

### BACKGROUND OF THE INVENTION

In the related arts, a plastic chrome plating method has been applied to all interior and exterior plastic parts of a vehicle as well as decorative decoration parts. For instance, as shown in FIG. 3, plastic plating parts have been applied for various parts of a vehicle.

Materials widely used as plating plastics include acrylonitrile-butadiene-styrene (ABS) and a resin (matrix) including polycarbonate (PC) and ABS. In order to perform such an electroplating process, a process of primary chemical plating is required. For instance, butadiene in a surface ABS may be oxidized by chromic acid/sulfuric acid etching in the chemical plating process, so that a pore may be formed. The formed pore is called an anchor hole because it plays a most important role in imparting physical bonding force between a metal layer and an ABS that are formed and stacked in a subsequent plating process.

In the related arts, as shown in FIG. 4, in a metal plating process, a raw material is injected and then an etching process is performed. During the etching process, anchor holes are formed in the ABS surface by using chromic acid/sulfuric acid (e.g., CrO₃/H₂SO₄). Subsequently, a chemical plating (e.g., surface conductivity imparting) process may be performed, which may include a neutralization/reduction process, an activation process, and a chemical Ni layer production process. Thereafter, an electroplating process for creating a metal layer on a surface is performed. This process may include Cu production, Ni production, and Cr production processes.

When the anchor holes are not properly formed, a plating layer may not have sufficient adhesion. This may result in exfoliation of the plating layer, which may be a fatal defect leading to personal injury when it occurs at hand-contact parts such as handles, buttons, and knobs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In preferred aspects, provided herein is a complex material composition (the “composition” or “plastic composition”) that may improve adhesion and various properties between a plating layer and plastic in various materials for a vehicle.

In one aspect, the present invention provides a composition that may include: an amount of about 60 to 90 wt % of a polymer matrix based on the total weight of the composition, and an amount of about 10 to 40 wt % of an inorganic filler based on the total weight of the composition. The polymer matrix may include an amount of about 60 to 90 wt % of a polycarbonate-based polymer and ab amount of about 10 to 40 wt % of a butadiene-based copolymer based on the total weight of the polymer matrix. According to the exemplary embodiment of the present invention, the composition including the inorganic filler may be formed in a polymer layer (“plastic layer”) of a vehicle part and a plating layer of the vehicle part may be formed on the composition such that adhesion of the polymer layer to the plating layer may be improved.

The term “filler” as used herein refers to a material that is typically incorporated into a resin (e.g., polymeric resin composition) in order to modify the properties of the resin. The term “inorganic filler” as used herein refers to an inorganic material (non-organic material) used as a filler, including elements other than only carbon such as P, S, Si, 0, N, B, metals, halogen and the like.

A size of the inorganic filler may be in a range of about 0.5 to 15 μm, of about 0.5 to 5 μm, or particularly of about 0.5 to 2 μm, in which an adhesion area with the plating layer may be maximized due to an organic relationship with anchor holes formed in a butadiene-based copolymer.

Typically, the term “size” or “particle diameter” of a particle (e.g., particle of the inorganic filler) refers to a maximum value of the size measured. For instance, the size or the particle diameter may be measured along the direction that has the greatest value of measured length.

The polymer matrix may suitably include the polycarbonate-based polymer in an amount of about 40 to 60 wt % based on the total weight of the polymer matrix.

The butadiene-based copolymer may suitably include an acrylonitrile-butadiene-styrene copolymer.

The inorganic filler may suitably include whiskers, talc, calcium carbonate, kaolin, or a combination thereof.

The inorganic filler may suitably include whiskers in an amount of about be 10 to 20 wt % based on the total weight of the composition. The whiskers may include magnesium sulfate.

The inorganic filler may suitably include talc in an amount of about 10 to 30 wt % based on the total weight of the polymer matrix.

The inorganic filler may suitably include calcium carbonate in an amount of about 10 to 40 wt % based on the total weight of the polymer matrix.

The inorganic filler may suitably include kaolin in an amount of about 10 to 40 wt % based on the total weight of the polymer matrix.

In another aspect, provided is a vehicle part that may include a plating layer; and a polymer layer comprising the composition as described herein. The plating layer may be formed on the polymer layer.

Also provided is a method of manufacturing the vehicle part. The method may suitably include forming a layer comprising the composition as described herein, and etching the inorganic filler in the composition. In the etching, chromic acid/sulfuric acid may suitably be used. Further provided is a vehicle that may include the vehicle part as described herein.

A detailed description for a kind and content of the inorganic filler will be given in the following exemplary embodiments.

According to an embodiment of the present invention, it is possible to improve adhesion and various properties between a plating layer and plastic in various materials for a vehicle.

### BRIEF DESCRIPTION OF THE DRAWINGS

FIG. 1 is a scanning electron microscopic (SEM) photograph showing interfacial anchor holes in the comparative example.

FIG. 2 is an SEM photograph showing exemplary interfacial anchor holes according to an exemplary embodiment of the present invention.

FIG. 3 is a schematic diagram showing exemplary plastic plating parts for an exemplary vehicle where the composition may be variously applied.

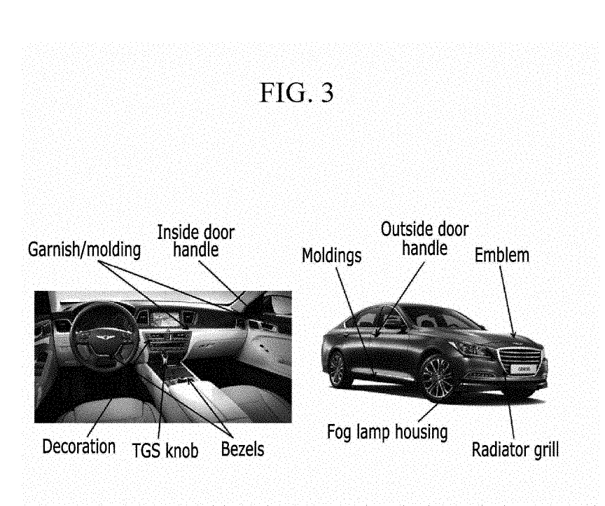

FIG. 4 is a schematic diagram of an exemplary metal plating process according to an exemplary embodiment of the present invention.

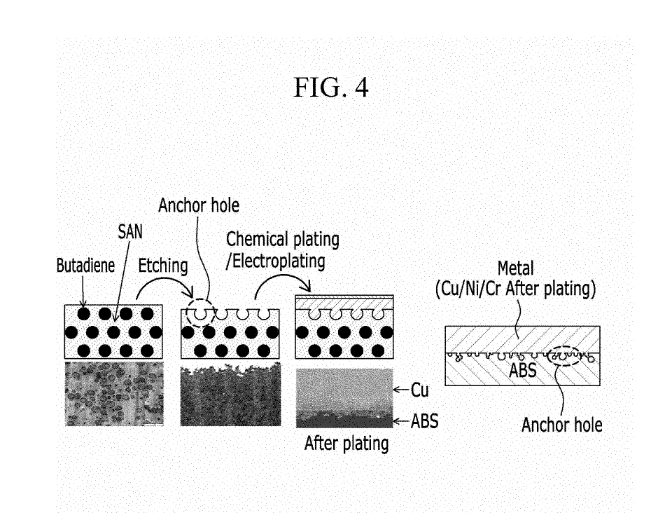

### DETAILED DESCRIPTION OF THE EMBODIMENTS

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In one aspect, the present invention provides a composition that may include: an amount of about 60 to 90 wt % of a polymer matrix based on the total weight of the composition, and an amount of about 10 to 40 wt % of an inorganic filler based on the total weight of the composition. The polymer matrix may include an amount of about 60 to 90 wt % of a polycarbonate-based polymer and ab amount of about 10 to 40 wt % of a butadiene-based copolymer based on the total weight of the polymer matrix.

When a content of the inorganic filler is greater than the predetermined amount, e.g., greater than about 40 wt % based on the total weight of the composition, impact strength of a material may deteriorate, and when the content of the inorganic filler is less than the predetermined amount, e.g., less than about 10 wt % based on the total weight of the composition, the adhesion to the plating layer may be insignificantly improved.

A particle diameter of the inorganic filler may be in a range of about 0.5 to 15 μm, of about 0.5 to 5 μm, or particularly of about 0.5 to 2 μm, in which an adhesion area with the plating layer may be maximized due to an organic relationship with anchor holes formed in a butadiene-based copolymer.

The polymer matrix may suitably include the polycarbonate-based polymer in an amount of about 40 to 60 wt % based on the total weight of the polymer matrix. The butadiene-based copolymer may suitably include an acrylonitrile-butadiene-styrene copolymer.

The inorganic filler may suitably include whiskers, talc, calcium carbonate, kaolin, or a combination thereof. The inorganic filler may suitably include whiskers in an amount of about be 10 to 20 wt % based on the total weight of the composition. The whiskers may include magnesium sulfate. The inorganic filler may suitably include talc in an amount of about 10 to 30 wt % based on the total weight of the polymer matrix. The inorganic filler may suitably include calcium carbonate in an amount of about 10 to 40 wt % based on the total weight of the polymer matrix. The inorganic filler may suitably include kaolin in an amount of about 10 to 40 wt % based on the total weight of the polymer matrix.

In another aspect, the present invention provides a vehicle part that may include a plating layer; and a polymer layer comprising the composition as described herein. The plating layer may be formed on the polymer layer.

In another aspect, the present invention provides a method of manufacturing the vehicle part. The method may suitably include forming a layer comprising the composition as described herein, and etching the inorganic filler in the composition. In the etching, chromic acid/sulfuric acid (e.g., CrO₃/H₂SO₄) may suitably be used. The method may further include forming a plating layer on the layer. For example, the plating layer may include Cu, Ni, or Cr. In another aspect, the present invention provides vehicle that may include the vehicle part as described herein.

### EXAMPLE

Hereinafter, exemplary embodiments of the present invention will be described in detail. The exemplary embodiments, however, are provided as examples, and the present invention is not limited thereto, but is defined within the range of claims to be described below.

### Exemplary Embodiments and Comparative Example

As shown in Table 1, plastic compositions were prepared according to compositions of exemplary embodiments and a comparative example.

In addition, plastics having these compositions were plated with metal, and various properties of plastics including plating layers were evaluated.

More specifically, four inorganic particles of whiskers, fine talc, CaCO₃, and kaolin were mixed in a matrix including PC and ABS using a twin-screw extruder at a temperature of about 250° C. as in Exemplary Examples 1 to 13 shown in Table 1, and standard test pieces injected at an injection temperature of 250° C. were tested.

TABLE 1

| | | Exemplary | Exemplary | Exemplary | Exemplary | Exemplary | Exemplary | Exemplary | Exemplary | Exemplary | Exemplary | Exemplary | Exemplary | Exemplary | Com- |
|---|---|---|---|---|---|---|---|---|---|---|---|---|---|---|---|
| | | Embodiment | Embodiment | Embodiment | Embodiment | Embodiment | Embodi- | Embodiment | Embodiment | embodiment | Embodiment | Embodiment | Embodiment | Embodiment | parative |
| | Unit | 1 | 2 | 3 | 4 | 5 | ment 6 | 7 | 8 | 9 | 10 | 11 | 12 | 13 | Example |
| PC + | wt % | 90 | 80 | 90 | 80 | 70 | 90 | 80 | 70 | 60 | 90 | 80 | 70 | 60 | 100 |
| ABS | | | | | | | | | | | | | | | |
| content | | | | | | | | | | | | | | | |
| (PC:based | | | | | | | | | | | | | | | |
| on | | | | | | | | | | | | | | | |
| ABS | | | | | | | | | | | | | | | |
| 5:5) | | | | | | | | | | | | | | | |
| Whisker | wt % | 10 | 20 | — | — | — | — | — | — | — | — | — | — | — | — |
| content | | | | | | | | | | | | | | | |
| Talc | wt % | 0 | 0 | 10 | 20 | 30 | — | — | — | — | — | — | — | — | — |
| content | | | | | | | | | | | | | | | |
| CaCO₃ | wt % | — | — | — | — | — | 10 | 20 | 30 | 40 | — | — | — | — | — |
| content | | | | | | | | | | | | | | | |
| Kaolin | wt % | — | — | — | — | — | — | — | — | — | 10 | 20 | 30 | 40 | — |
| content | | | | | | | | | | | | | | | |
| Total | % | 100 wt % | 100 wt % | 100 wt % | 100 wt % | 100 wt % | 100 wt % | 100 wt % | 100 wt % | 100 wt % | 100 wt % | 100 wt % | 100 wt % | 100 wt % | 100 wt % |
| Heat | Parts | 0.5 | 0.5 | 0.5 | 0.5 | 0.5 | 0.5 | 0.5 | 0.5 | 0.5 | 0.5 | 0.5 | 0.5 | 0.5 | 0.5 |
| stabilizer | by | | | | | | | | | | | | | | |
| | weight | | | | | | | | | | | | | | |
| Lubricant | Parts | 0.3 | 0.3 | 0.3 | 0.3 | 0.3 | 0.3 | 0.3 | 0.3 | 0.3 | 0.3 | 0.3 | 0.3 | 0.3 | 0.3 |
| | by | | | | | | | | | | | | | | |
| | weight | | | | | | | | | | | | | | |

Evaluation

| | | | | | | | | | | | | | | | |
|---|---|---|---|---|---|---|---|---|---|---|---|---|---|---|---|
| MI | g/ | 180 | 70 | 25 | 21 | 18 | 29 | 25 | 26 | 29 | 25 | 20 | 17 | 12 | 35 |
| | 10 min | | | | | | | | | | | | | | |
| Tensile | MPa | 42 | 44 | 40 | 41 | 42 | 39 | 37 | 40 | 38 | 41 | 41 | 42 | 44 | 40 |
| strength | | | | | | | | | | | | | | | |
| Flexural | MPa | 63 | 67 | 59 | 62 | 63 | 59 | 59 | 60 | 62 | 60 | 64 | 66 | 68 | 58 |
| strength | | | | | | | | | | | | | | | |
| Flexural | MPa | 2500 | 4100 | 2120 | 2950 | 3430 | 1750 | 2040 | 2670 | 3450 | 1740 | 2200 | 2550 | 3020 | 1680 |
| modulus | | | | | | | | | | | | | | | |
| Impact | J/m | 30 | 24 | 230 | 82 | 68 | 313 | 279 | 137 | 51 | 222 | 91 | 50 | 33 | 470 |
| strength | | | | | | | | | | | | | | | |
| Heat | ° C. | 97 | 102 | 97 | 103 | 105 | 94 | 96 | 94 | 95 | 95 | 97 | 101 | 103 | 92 |
| deflection | | | | | | | | | | | | | | | |
| temper- | | | | | | | | | | | | | | | |
| ature | | | | | | | | | | | | | | | |
| Plating | N/cm | 8.6 | 11.3 | 6.7 | 8.3 | 9.9 | 5.8 | 6.1 | 6.9 | 8.6 | 5.8 | 5.9 | 6.8 | 7.8 | 5.1 |
| adhesion | | | | | | | | | | | | | | | |

Specific kinds of inorganic fillers used in Table 1 are as follows.

TABLE 2

| Material name | Constituent component | Size (μm) |
|---|---|---|
| Whiskers | MgSO₄ • 5Mg (OH)₂ • 3H₂O | 7-11 |
| (magnesium sulfate) | | |
| Fine talc | 3MgO, 4SiO₂, H₂O | 3-4 |
| Calcium carbonate | CaCO₃ | 1-2 |
| Kaolin | Al₂Si₂O₅ (OH)₄ | 1-2 |

In Table 2, the kind and the content of the filler were adjusted by one of whisker, talc, calcium carbonate, and kaolin.

A method for the evaluation of Table 1 is as follows.

TABLE 3

| Evaluation item | Evaluation standard | Test condition |
|---|---|---|
| MI | ASTM D1238 | 230° C., 21.6 kg |
| Tensile strength | ASTM D638 | 50 mm/min |
| Flexural strength | ASTM D790 | 10 mm/min |
| Flexural modulus | ASTM D790 | 10 mm/min |
| Impact strength | ASTM D256 | 30 kgf |
| Heat deflection temperature | ASTM D648 | 1.8 MPa |
| Plating adhesion | HKMC self-evaluation | 50 mm/min |
| | (90° exfoliation test) | |

According to methods of Table 3, specimens were prepared by injecting tensile/flexural standard specimens, and then were evaluated.

With regard to the plating adhesion, after a flat plate test piece of 10×10 cm² was injected, anchor holes were formed by etching an ABS surface with a 1:1 mixture of chromic acid/sulfuric acid (CrO₃/H₂SO₄), then the chemical plating including sequentially performing a neutralization/reduction process, an activation process, and a production process of a chemical Ni layer was performed, and then Cu/Ni/Cr layers were sequentially formed using an electroplating process. In this case, 20 μm, 10 μm, and 0.25 μm as standard thicknesses were respectively applied as the Cu layer, the Ni layer, and the Cr layer, and then the layers were exfoliated in a direction of 90° to apply an average value of exfoliation distance of about 50 mm.

In the case of the whiskers of the exemplary embodiments of Table 1, when the content of the whiskers was greater than 20 wt %, extrusion was impossible. In the case of the talc, when the content of the talc was greater than 30 wt %, extrusion was impossible.

Particularly, when the whiskers of 30 wt % or more were mixed, the extrusion was impossible, but the plating adhesion thereby was significantly greater than that by the matrix including PC and ABS alone until 20 wt % thereof.

When the talc of 40 wt % or more was mixed, the extrusion was impossible, but the plating adhesion thereby was greater than that by the matrix including PC and ABS alone until 30 wt % thereof, and impact resistance thereby was superior to that of the whiskers in the same content.

In addition, heat resistance by the whiskers and the talc was increased by about 10° C. or more as compared with that by the matrix including PC and ABS alone.

In the cases of the CaCO₃ and the kaolin, extrusion was possible up to 40 wt % thereof, but when they were mixed at 20 wt % or less, the plating adhesion thereby was insignificantly improved. However, when they were mixed at 30 to 40 wt %, the plating adhesion thereby were improved.

Generally, when an ABS or matrix including PC and ABS is plated, intaglio anchor holes are formed on a surface thereof in an etching process. Preferably, according to various exemplary embodiments of the present invention, when the inorganic filler is included in the polymer layer (“layer” or “plastic layer”), an effect of embossing may be amplified to the anchor holes, thereby causing a synergistic effect of the plating adhesion.

The whiskers generally have a size of 7 to 11 μm in a length direction or at a diameter having a maximum value. When the length thereof is about 5 μm or less, a physical reinforcing effect may be reduced and a synergistic effect of adhesion may be decreased. When the length thereof is about 15 μm or greater, the physical reinforcing effect may be further increased. In this case, since appearance deteriorates after plating, it may not be suitable as a filler for a plating material.

The fine talc may suitably have a size of about 3 to 4 μm, the CaCO₃ may suitably have a size of about 1 to 2 μm, and the kaolin may suitably have a size of about 1 to 2 μm and they may have planar or spherical shapes. When a diameter of these particles increases (e.g., greater than about 5 μm), the plating adhesion may be decreased or the plating appearance may be deteriorated. In addition, mass production of talc, CaCO₃, and kaolin at a nanometer level of 1 μm or less may be difficult, and mass production may be difficult due to cost problems.

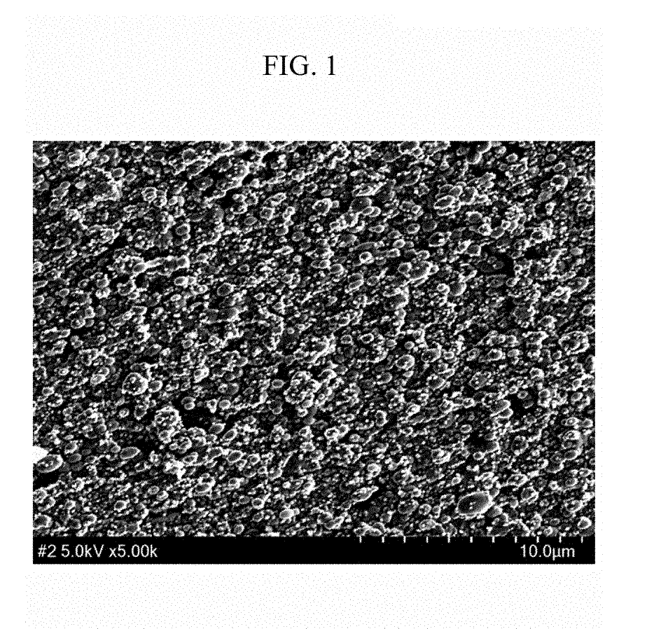

FIG. 1 is a scanning electron microscopic (SEM) photograph showing a state of interfacial anchor holes according to the Comparative Example in Table 1.

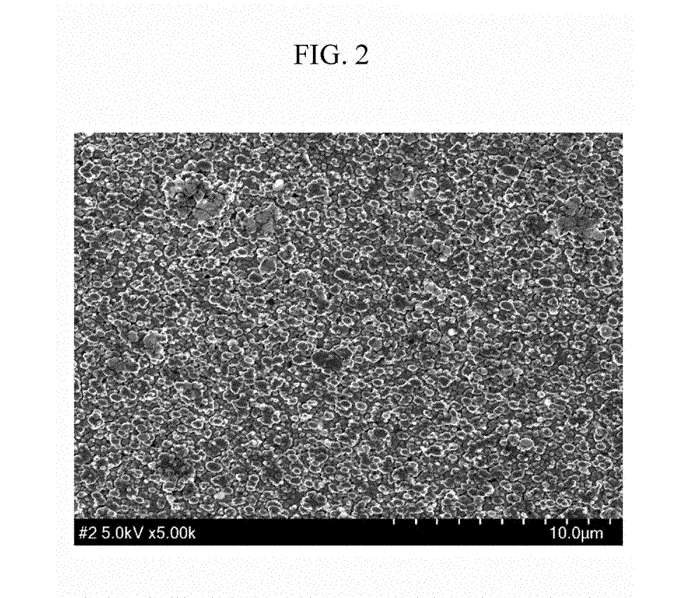

FIG. 2 is an SEM photograph showing exemplary interfacial anchor holes according to an exemplary embodiment of the present invention.

In the case of FIG. 2 according to the exemplary embodiment, the anchor holes having a size of about 1 to 3 μm, which is a filler particle diameter, were partially observed, and an overall specific surface area was increased.

The composition according to the exemplary embodiment of the present invention may provide substantially improved mechanical properties, heat resistance, and plating adhesion, while maintaining the appearance, compared to the ABS or matrix including PC and ABS without the filler.

Generally, the matrix including PC and ABS has excellent mechanical properties compared to the ABS, but the plating adhesion thereof may be poor because it lacks butadiene content compared to the ABS alone.

According to various exemplary embodiments of the present invention, by mixing the inorganic filler used in the present invention thereinto, the plating adhesion of the conventional matrix including PC and ABS plating may be increased to a level of that of the ABS.

In addition, the matrix including PC and ABS is more expensive than the ABS. So, when a low-priced inorganic filler is mixed therein, the matrix including PC and ABS content relatively decreases as the inorganic filler content increases, the cost may be reduced.

The composition of the exemplary embodiment of the present invention may be used as a material for plating such as of internal/external parts, and it is possible to reduce a problem related to plating exfoliation when replacing the conventional material used for hand-contact parts.

While this invention has been described in connection with what is presently considered to be preferred exemplary embodiments, it is to be understood that the invention is not limited to the disclosed embodiments, but, on the contrary, is intended to cover various modifications and equivalent arrangements included within the spirit and scope of the appended claims.

1. A composition comprising
an amount of about 60 to 90 wt % of a polymer matrix based on the total weight of the complex material composition, and
an amount of about 10 to 40 wt % of an inorganic filler based on the total weight of the complex material composition.

2. The composition of claim 1, wherein a particle diameter of the inorganic filler is of about 0.5 to 15 μm.

3. The composition of claim 1, wherein the polymer matrix comprises the polycarbonate-based polymer in an amount of about 40 to 60 wt % based on the total weight of the polymer matrix.

4. The composition of claim 1, wherein the butadiene-based copolymer comprises an acrylonitrile-butadiene-styrene copolymer.

5. The composition of claim 1, wherein the inorganic filler comprises whiskers, talc, calcium carbonate, kaolin, or a combination thereof.

6. The composition of claim 1, wherein the inorganic filler comprises whiskers in an amount of about 10 to 20 wt % based on the total weight of the composition.

7. The composition of claim 6, wherein the whiskers comprises magnesium sulfate.

8. The composition of claim 1, wherein the inorganic filler comprises talc in an amount of about 10 to 30 wt % based on the total weight of the composition.

9. The composition of claim 1, wherein the inorganic filler comprises calcium carbonate in an amount of about 10 to 40 wt % based on the total weight of the composition.

10. The composition of claim 1, wherein the inorganic filler comprises kaolin in an amount of about 10 to 40 wt % based on the total weight of the composition.

11. A vehicle part comprising:
a plating layer; and
a polymer layer comprising a composition of claim 1,
wherein the plating layer is formed on the polymer layer.

12. A method of manufacturing a vehicle part, comprising:
forming a layer comprising a composition, wherein the composition comprises an amount of about 60 to 90 wt % of a polymer matrix based on the total weight of the complex material composition and an amount of about 10 to 40 wt % of an inorganic filler based on the total weight of the complex material composition, and
etching the inorganic filler in the composition.

13. The method of claim 12, wherein the etching is performed by using chromic acid and/or sulfuric acid.

14. The method of claim 12, wherein the method further comprises forming a plating layer on the layer.
